(19) United States
(12) Patent Application Publication
(10) Pub. No.: US 2026/0209025 A1
(43) Pub. Date: Jul. 23, 2026

(54) SMART HUB FOR WATER DISPENSER

(71) Applicant: BE WTR SA, Lausanne (CH)

(72) Inventors: Etienne LEBRETON, Crissier (CH); Jean-Luc DENISART, Cully (CH); Philippe BAENNIGER, Epalinges (CH)

(73) Assignee: BE WTR SA, Lausanne (CH)

(21) Appl. No.: 19/125,196

(22) PCT Filed: Oct. 23, 2023
(86) PCT No.: PCT/IB2023/060675

§ 371 Date: Apr. 28, 2025

(30) Foreign Application Priority Data
Oct. 27, 2022 (CH) CH001268/2022

(51) Int. Cl. B67D 1/08; B67D 1/00

(52) U.S. Cl. CPC B67D 1/0888; B67D 1/0014; B67D 1/0878; B67D 2210/0001

(57) ABSTRACT

A smart hub for a water dispenser, comprising a housing and a receiving portion for receiving a filter intended for filtering water from a water supply network. The housing comprises: a first inlet port in fluid communication with the receiving portion for the inflow of unfiltered water from the distribution network; a first outlet port in fluid communication with the receiving portion and arranged to be connected to a cooling unit; a second inlet port arranged to be connected to the cooling unit in order to receive refrigerated still water; a first flow sensor in fluid communication with the second inlet port in order to measure a volume of refrigerated still water; a second outlet port for dispensing the volume of refrigerated still water; a third inlet port arranged to be connected to the cooling unit in order to receive refrigerated carbonated water; a second flow sensor in fluid communication with the third inlet port in order to measure a volume of refrigerated carbonated water; and a third outlet port for dispensing the volume of refrigerated carbonated water. The smart hub further comprises an electronic circuit including a microcontroller and an antenna for computing and transmitting data relating to the operation of the water dispenser to a computer terminal. The invention also relates to a water dispenser comprising the smart hub and a cooling unit.

### TECHNICAL FIELD

The invention relates to a smart hub for a water dispenser, as well as to a water dispenser comprising the smart hub, which includes a filter and is connected to a cooling unit. The smart hub is intended for transmitting data relating to the operation of the water dispenser to a computer terminal via a cloud service, in particular in order to manage after-sales service.

### PRIOR ART

There are different types of water dispensers comprising one or more filters and a cooling unit. One type of water dispenser is the water fountain, commonly found in offices or private residences. Water fountains are designed either for use with water bottles, which typically have a capacity of around 20 litters and are reusable, or to be connected to a water supply network. Another type of water dispenser is commonly found in restaurants and bars. In this case, the filter and the cooling unit are generally placed under a counter, which comprises electronic or mechanical taps connected to the cooling unit through openings made through the counter.

In recent years, it has been shown that reusable plastic bottles present issues related to water quality due to bacterial growth and chemical contamination of the water by the plastic. In many countries where water quality is acceptable, the dominant configuration of water dispensers includes a connection to a water supply network, a filter typically containing activated carbon, a cooling unit including a chiller and possibly a carbonator, as well as a mechanical or electronic tap. Such a configuration is schematically illustrated in FIG. 1.

In most water dispensers with electronic tap, the valves are located within the cooling unit. The electronic tap sends an electronic command to the cooling unit to open and close the valves. In this configuration, carbon dioxide may remain in the conduit connecting the cooling unit after the tap is closed, which leads to degassing and dripping when the tap is shut. To address this issue, still water is automatically injected into the conduit at the end of each dispensing cycle of carbonated water. This solution prevents dripping but compromises the performance and usability of electronic taps without integrated valves, which are less effective than mechanical or electronic taps with integrated valves when it comes to dispensing carbonated water.

### BRIEF SUMMARY OF THE INVENTION

An aim of the present invention is therefore to propose a water dispenser, particularly equipped with an electronic tap, that addresses the aforementioned drawbacks.

More particularly, an aim of the present invention is to propose a water dispenser capable of dispensing an amount of water without dripping, both with still water and with carbonated water.

Another objective of the present invention is to propose a smart hub for a water dispenser, intended to be connected to a cooling unit in order to collect data for monitoring the operation of the water dispenser.

According to the invention, these aims are achieved, in particular, by a smart hub for a water dispenser, comprising a housing and a receiving portion for receiving a filter intended for filtering water from a water supply network. The housing of the smart hub comprises: a first inlet port in fluid communication with the receiving portion for the inflow of unfiltered water from the supply network; a first outlet port in fluid communication with the receiving portion and arranged to be connected to a cooling unit; a second inlet port arranged to be connected to the cooling unit in order to receive refrigerated still water; a first flow sensor in fluid communication with the second inlet port in order to measure a volume of refrigerated still water; a second outlet port for dispensing the volume of refrigerated still water; a third inlet port arranged to be connected to the cooling unit in order to receive refrigerated carbonated water; a second flow sensor in fluid communication with the third inlet port in order to measure a volume of refrigerated carbonated water; and a third outlet port for dispensing the volume of refrigerated carbonated water. The smart hub further comprises an electronic circuit including a microcontroller and an antenna for computing and transmitting data related to the operation of the water dispenser to a computer terminal.

According to an embodiment, the receiving portion includes a threaded part to receive, by screwing, one end of a filter.

According to an embodiment, the smart hub further comprises a filter detector including an actuator and a switch connected to the electronic circuit. The actuator is arranged partially in the receiving portion to be moved by the end of the filter in order to activate the switch, which is connected to the electronic circuit.

According to an embodiment, the first and second flow sensors each include a float equipped with a magnet. A detector is arranged against a wall of each flow sensor to detect the position of the respective floats.

According to an embodiment, an electrically actuable valve is arranged between the first inlet port and the receiving portion of the filter.

According to an embodiment, the housing comprises a top side and a bottom side opposite the top side. The top side includes the first inlet and outlet ports for the inflow of unfiltered water and the outflow of filtered water, as well as the second and third outlet ports for dispensing, respectively, a volume of refrigerated still water and a volume of refrigerated carbonated water.

According to an embodiment, the bottom side includes the second and third inlet ports, which are arranged coaxially with the second and third outlet ports.

According to an embodiment, the smart hub further comprises a leak detector connected to the housing and positioned on the floor near the hub.

According to an embodiment, the housing further comprises a connector for a conduit connected to a gas bottle. The connector is linked to a flexible conduit arranged inside the housing. A distal end of the flexible conduit is positioned against a pressure sensor of the electronic circuit in order to determine the gas level in the bottle.

Another aspect of the invention relates to a water dispenser comprising the smart hub according to any of the aforementioned embodiments and a cooling unit. The cooling unit includes a water circuit comprising a chiller and a carbonator downstream of the chiller. The cooling unit further includes an inlet port connected to the first outlet port of the smart hub, a first outlet port connected to the second inlet port of the smart hub, and a second outlet port connected to the third inlet port of the smart hub.

Another aspect of the invention relates to a method for measuring parameters, notably the water consumption of the water dispenser. The method comprises the following steps:
i) measuring the consumption of refrigerated still water and refrigerated carbonated water over a predetermined interval based, on the one hand, on a flow value estimated using an electrically actuable valve with a flow sensor arranged between the first inlet port and the receiving portion of the smart hub, and on the other hand, on the position of a first and a second float respectively in the first and second flow sensors as measured by a detector; then
ii) transmitting said consumption together with an identifier from the smart hub to a computer terminal.

According to an embodiment, the method further comprises: i) measuring a gas pressure using a pressure sensor of the electronic circuit of the smart hub in order to determine the gas level in a gas bottle, then ii) transmitting this data together with the identifier of the smart hub to the computer terminal.

According to an embodiment, the method further comprises: i) evaluating the filter sate by the electronic circuit based on the total volume of water measured by the electrically actuable valve and the intrinsic characteristics of the filter; then ii) transmitting the filter state together with the identifier of the smart hub to the computer terminal.

### BRIEF SUMMARY OF THE FIGURES

Embodiments of the invention are provided in the description illustrated by the accompanying figures, in which:

FIG. 1 illustrates a schematic view of a conventional water dispenser;

FIG. 2 illustrates a schematic view of a connected water dispenser, according to the invention;

FIG. 3 illustrates a schematic view of the dispenser from FIG. 2 in communication with a computer terminal via a cloud platform;

FIG. 4 illustrates a perspective view of the smart hub with a filter screwed into it;

FIG. 5a illustrates a top view of FIG. 4;

FIG. 5b illustrates a bottom view of FIG. 4;

FIG. 6 illustrates a perspective view of the housing of the smart hub with the components inside the housing;

FIG. 7 illustrates a cross-sectional view of the filter receiving portion and of a filter detector;

FIG. 8 illustrates a cross-sectional view of FIG. 6 at the first inlet and outlet ports with a partial view of the filter screwed into the receiving portion of the smart hub;

FIG. 9 illustrates a cross-sectional view of FIG. 6 at the flow sensors, and

FIG. 10 illustrates the location of the electronic circuit inside the housing.

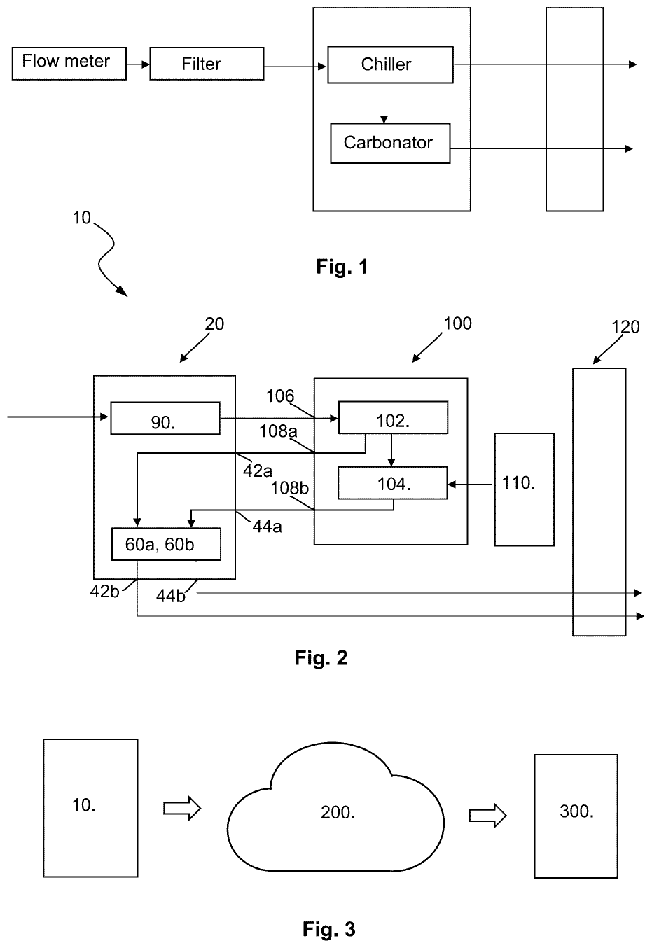

### EXAMPLES OF EMBODIMENTS OF THE INVENTION

With reference to FIG. 2, the water dispenser 10 comprises a smart hub 20 connected to a cooling unit 100, which includes a chiller 102 and a carbonator 104 connected to a gas bottle 110. The smart hub 20 includes a filter 90 for filtering water from a supply network, as well as a first and second flow sensor 60a, 60b for measuring a volume of still or carbonated water coming from the cooling unit 100.

The filtered water is directed into the cooling unit 100 through an inlet port 106 to be cooled by the chiller 102 and, if necessary, carbonated by the carbonator 104. The cooling unit 100 includes a first and second outlet port 108a, 108b to redirect the refrigerated and carbonated water into the smart hub 20 as described below. The refrigerated water and the carbonated water are then routed to one or two taps 120, which can be either electronic or mechanical.

With reference to FIG. 3, the smart hub 20 is configured to transmit an identifier along with data related to the operation of the water dispenser 10 to a computer terminal 300 via a cloud platform 200, such as Amazon Web Services (AWS). The computer terminal 300 may run software for customer relationship management, particularly to improve after-sales service based on the received data. The computer terminal 300 may, for example, be a computer, a tablet, or a smartphone.

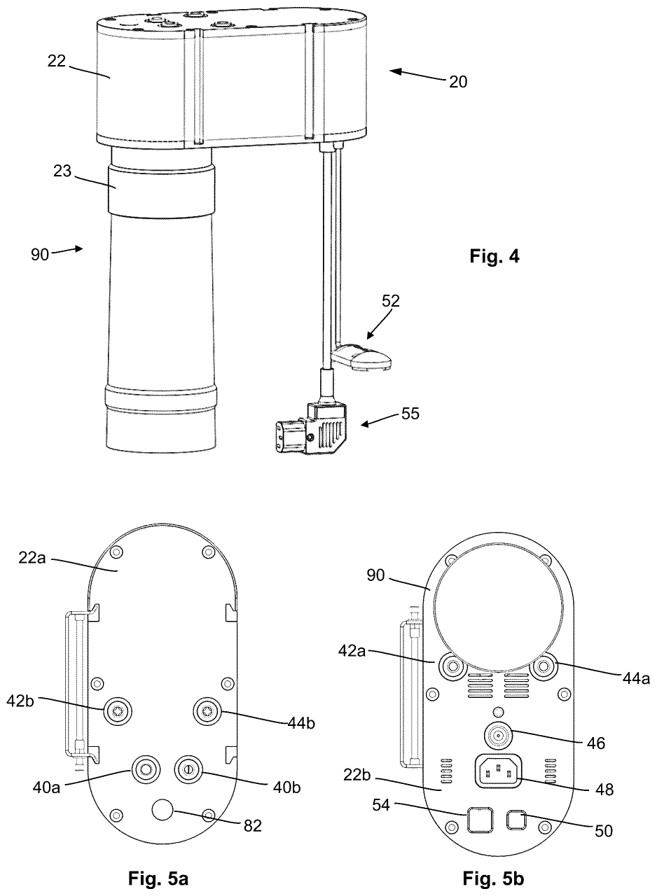

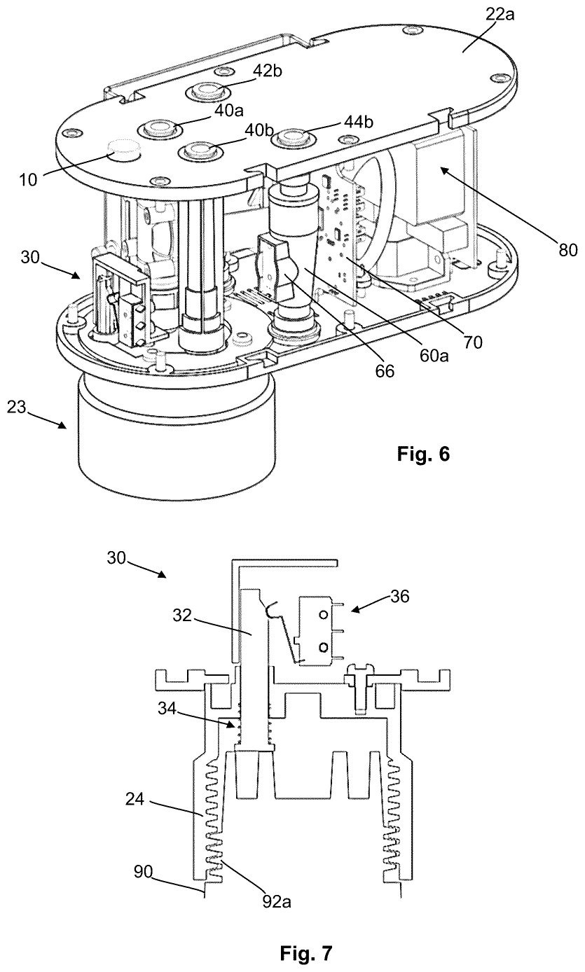

With reference to FIGS. 4 to 10, the smart hub 20 comprises a housing 22, and a receiving portion 23 fixed to the housing and including a threaded part 24 into which a threaded part 92 of a filter 90 is screwed. According to FIGS. 6, 8, and 9, the housing includes, in particular, a filter detector 30, the first and second flow sensors 60a, 60b, an electronic circuit 70, and a power module 80.

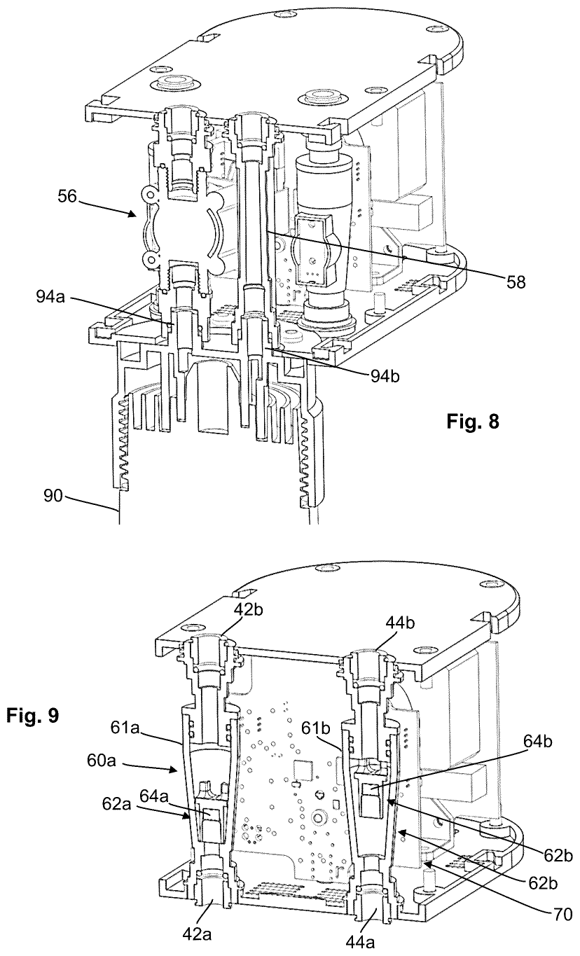

The housing 22 comprises a top side 22a and a bottom side 22b. According to FIG. 5a, the top side 22a includes a first inlet port 40a for the inflow of unfiltered water from the water supply network, and a first outlet port 40b for the outflow of filtered water. As shown in FIG. 8, an electrically actuable valve 56, of the NC type and incorporating a flow sensor, is arranged between the first inlet port 40a and an inlet port 94a of the filter 90. A conduit 58 extends from an outlet port 94b of the filter 90 to the first outlet port 40b of the smart hub.

According to FIG. 5b, the bottom side 22b of the housing 20 includes a second inlet port 42a arranged to be connected to the cooling unit 100 in order to receive refrigerated still water, as well as a third inlet port 44a to be connected to the cooling unit 100 in order to receive refrigerated carbonated water. The bottom side 22b of the housing also includes a power input 48 for the smart hub 20, a connector 46 for connecting to a gas bottle 110, a connector 54 for a power cable 55 intended to supply electricity to the cooling unit 100, and a connector 50 for a leak detector 52 designed to rest on the floor to detect any water leaks around the smart hub.

The top side 22a of the housing 20 includes a second and a third outlet port 42b, 44b for the outflow of refrigerated still water and refrigerated carbonated water, respectively. These outlet ports are intended to be connected to two separate taps or to a common tap for dispensing still and carbonated refrigerated water. The top side also includes an indicator 82 designed to provide the user with various operational and maintenance information for the water dispenser based on a colour code. For example, the indicator may change to a first colour when the smart hub is in standby mode, to a second colour when the smart hub is in operation, to a third colour to notify the user that the filter needs to be replaced, and to a fourth colour when the gas bottle needs to be replaced.

Referring to FIGS. 6 and 7, the smart hub 20 further includes a filter detector 30 comprising an actuator 32 and a switch 36 connected to the electronic circuit 70. The actuator 32 is, for example, in the form of a rod mounted in a cylindrical opening of the filter receiving portion 23. The rod 23 is biased by an elastic member into a first axial position when no filter is screwed into the smart hub. The elastic member is preferably in the form of a compression spring 24 arranged around the rod 23 and resting on a bearing surface.

When a filter 90 is screwed into the receiving portion 23 of the hub 20, the rod 23 moves to a second axial position and toggles the switch 23 to indicate to the smart hub the presence of a filter. The filter detector 30 enables in particular the smart hub 20 to transmit a series of instructions to the user, via a display, for cleaning the hub using a chlorine cartridge based on the state of the filter detector 30. Once the filter is disconnected from the hub 20, the latter instructs the user to connect the chlorine cartridge. Once the cartridge is detected, the hub controls the electrically actuable valve 56 to allow a predetermined volume of water to flow into the cartridge. After the cleaning operation is completed, the user replaces the chlorine cartridge with the filter.

With reference to FIG. 9, the first and second flow sensors 60a, 60b include first and second conduits 61a, 61b connecting the second and third inlet ports 42a, 44a to the second and third inlet ports 42b, 44b of the smart hub 20. Each conduit includes, at a central portion, a float 62a, 62b comprising a magnet 64a, 64b. A detector 66, preferably a Hall effect sensor, is mounted against each conduit 61a, 61b at the central portion to measure a variation in the magnetic field generated by the axial movement of the floats 62a, 62b within the central portion of their respective conduits.

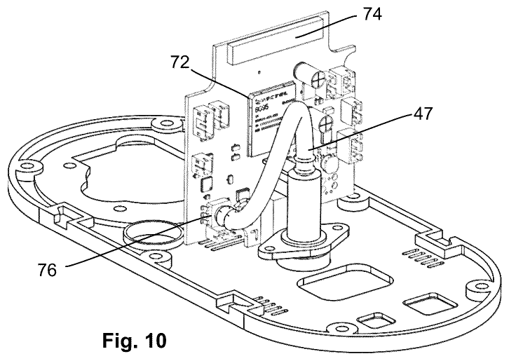

With reference to FIG. 10, the electronic circuit 70 includes, notably, a microcontroller 72, an antenna 74 for transmitting data to the computer terminal 300, and a pressure sensor 76. The connector 46 (FIG. 5b) of the gas bottle conduit 110 is connected to a conduit, preferably a flexible tube 47, disposed inside the housing 22. The flexible tube 47 has an end positioned against the pressure sensor 76 of the electronic circuit 70 to measure the pressure inside the gas bottle.

The microcontroller 72 of the electronic circuit 70 is intended to process various data measured by the different sensors described previously, including data related to the water flow passing through the electrically actuable valve 56, the variations in the magnetic field at the central part of the first and second flow sensors 60a, 60b, the pressure inside the gas bottle, as well as the status of the filter detector 30 and of the leak detector 52.

The microcontroller 72 can thus compute various data of a water dispenser 10 comprising the smart hub 20 and the cooling unit 100 in order to monitor the operation of the dispenser 10, the state of the filter 90, the gas level in the gas bottle 110, as well as any malfunctions, such as a water or gas leak.

The microcontroller can, for example, compute the volume of still and carbonated refrigerated water consumed within a predetermined interval. The volume can indeed be computed by the microcontroller 72 based on the flow of water passing through the electrically actuable valve 56 and the position of the floats 62a, 62b of the first and second flow sensors 60a, 60b, determined by the Hall effect sensors 66. The data provided by the flow sensors at the level of the electrically actuable valve 56 also allows the calculation of the filter state based on the intrinsic characteristics of the filter. The remaining gas level can also be calculated based on the data from the pressure sensor 76 transmitted to the microcontroller.

These data are then transmitted to the computer terminal 300, for example several times a day, with an identifier unique to the smart hub to enable optimal after-sales service. It is indeed possible to determine, in particular, the frequency of filter 90 and gas bottle 110 replacement based on the habits of still and carbonated water consumption, particularly for private residences, and based on the filter change date, the filter's expiration date, and/or the filter's capacity.

The user's consumption habits can also be transmitted, via the cloud platform 200, to the computer terminal 300 to establish a history of still and sparkling water consumption and to schedule the powering of the smart hub based on this history.

### REFERENCE LIST

Water dispenser 10
   Smart hub 20
      Housing 22
         First and second sides 22a, 22b
      Filter receiving portion 23
         Threaded part 24
         Filter detector 30
         Actuator 32
         Elastic member 34 (e.g. compression spring)
         Switch 36
      First inlet port 40a (unfiltered water)
      First outlet port 40b (filtered water)
      Second inlet port 42a (refrigerated water)
      Second outlet port 42b (measured refrigerated water)
      Third inlet port 44a (carbonated water)
      Third outlet port 44b (measured carbonated water)
      Connector 46 (for gas)
      Flexible tube 47
      Power input 48
      Connector 50 (for Leak detector)
      Leak detector 52
      Power connector 54
      Power cable 55
      Electrically actuable valve with flow sensor 56
      Conduit 58
      First and second flow sensors 60a, 60b
         Float 62a, 62b
         Magnet 64a, 64b
         Detector 66
         Hall effect sensor
      Electronic circuit 70
         Microcontroller 72
         Antenna 74
         Pressure sensor 76
      Power module 80
      Indicator 82
   Filter 90
      Threaded part 92
      Inlet port 94a
      Outlet port 94b
   Cooling unit 100
      Chiller 102
      Carbonator 104
      Inlet port 106
      First and second outlet port 108a, 108b
      Gas bottle 110
   Tap 120
   Cloud platform 200
   Computer terminal 300

1. Smart hub for a water dispenser, comprising a housing and a receiving portion for receiving a filter intended for filtering water from a water supply network, wherein the receiving portion is connected to the housing, the housing comprising:
a first inlet port in fluid communication with the receiving portion for the inflow of unfiltered water from the distribution network;
a first outlet port in fluid communication with the receiving portion and arranged to be connected to a cooling unit;
a second inlet port arranged to be connected to the cooling unit (100) in order to receive refrigerated still water;
a first flow sensor in fluid communication with the second inlet port in order to measure a volume of refrigerated still water;
a second outlet port for dispensing the volume of refrigerated still water;
a third inlet port arranged to be connected to the cooling unit in order to receive refrigerated carbonated water;
a second flow sensor in fluid communication with the third inlet port in order to measure a volume of refrigerated carbonated water; and
a third outlet port for dispensing the volume of refrigerated carbonated water,
the smart hub further comprising an electronic circuit including a microcontroller and an antenna for computing and transmitting data relating to the operation of the water dispenser to a computer terminal.

2. Smart hub according to claim 1, wherein said receiving portion includes a threaded part to receive, by screwing, one end of a filter.

3. Smart hub according to claim 2, further comprising a filter detector including an actuator and a switch connected to the electronic circuit, wherein the actuator is arranged partially in the receiving portion to be moved by said end of the filter in order to actuate the switch, which is connected to the electronic circuit.

4. Smart hub according to claim 1, wherein the first and second flow sensors each include a float equipped with a magnet, wherein a detector is arranged against a wall of each flow sensor to detect the position of the respective floats.

5. Smart hub according to claim 1, wherein an electrically actuable valve is arranged between the first inlet port and the receiving portion of the filter.

6. Smart hub according to claim 1, wherein the housing comprises a first side, referred to as a top side, and a second side opposite the first side, referred to as a bottom side, the top side including the first inlet and outlet ports for the inflow of unfiltered water and the outflow of filtered water, as well as the second and third outlet ports for dispensing, respectively, a volume of refrigerated still water and a volume of refrigerated carbonated water.

7. Smart hub according to claim 6, wherein the bottom side includes the second and third inlet ports, which are arranged coaxially with said second and third outlet ports.

8. Smart hub according to claim 1, further comprising a leak detector connected to the housing and positioned on the floor near the hub.

9. Smart hub according to claim 1, wherein the housing further comprises a connector for a conduit connected to a gas bottle, the connector being linked to a flexible conduit arranged inside the housing, a distal end of the flexible conduit being positioned against a pressure sensor of the electronic circuit in order to determine the gas level in the bottle.

10. Water dispenser comprising the smart hub according to claim 1 and a cooling unit including a water circuit comprising a chiller and a carbonator downstream of the chiller, the cooling unit further including an inlet port connected to the first outlet port of the smart hub, a first outlet port connected to the second inlet port of the smart hub, and a second outlet port connected to the third inlet port of the smart hub.

11. Method for measuring parameters, notably the water consumption, of the water dispenser according to claim 10, the method comprising the following steps:
measuring the consumption of refrigerated still water and refrigerated carbonated water over a predetermined interval based, on the one hand, on a flow value estimated using an electrically actuable valve with a flow sensor arranged between the first inlet port and the receiving portion of the smart hub, and on the other hand, on the position of a first and a second float respectively in the first and second flow sensors as measured by a detector; then
transmitting said consumption together with an identifier from the smart hub to a computer terminal.

12. Method according to claim 11, further comprising the measurement of a gas pressure using a pressure sensor of the electronic circuit of the smart hub in order to determine the gas level in a gas bottle, then the transmission of this data together with the identifier from the smart hub to the computer terminal.

13. Method according to claim 11 or 12, further comprising an evaluation of the state of the filter by the electronic circuit based on the total volume of water measured by the electrically actuable valve and the intrinsic characteristics of the filter; then the transmission of the filter state together with the identifier from the smart hub to the computer terminal.
